(19) United States
(12) Patent Application Publication
(10) Pub. No.: US 2025/0049043 A1
(43) Pub. Date: Feb. 13, 2025

(54) SYSTEM AND METHOD FOR WEIGHING DOUGH PORTIONS DURING PROOFING

(71) Applicant: Bakery Systems, Inc., St. Louis, MO (US)

(72) Inventor: Paul HEBENSTREIT, St. Louis, MO (US)

(21) Appl. No.: 18/231,616

(22) Filed: Aug. 8, 2023

(51) Int. Cl. A21C 5/00; G01G 11/00; G01G 19/413

(52) U.S. Cl. CPC A21C 5/00; G01G 11/003; G01G 19/413

(57) ABSTRACT

An apparatus and method for automatically removing dough pieces from overhead dough proffer, statically weighing the dough pieces and reinserting them back in to the proofer they were removed from in the process stream. The weight information is analyzed by a weighing mechanism which can include a weigh bucket or other means for weighing to determine whether it represents the weight of pieces or the empty weight, and may be used to provide a signal proportional to the weight of a dough portion, or group of dough portions in order to automatically adjust the rate at which dough is fed to the dividing mechanism, thereby increasing or decreasing the dough piece weights to maintain the desired amount of dough per piece.

### FIELD OF THE INVENTION

The described invention relates to an apparatus and method for weighing and adjusting the weight of dough pieces passing through a dough proofer at high production rates.

### BACKGROUND OF THE INVENTION

Commercial dough production often involves production of large quantities of dough which are continuously divided into portions using various types of dividing mechanisms, after the dough pieces are divided they are often rounded in shape and received in to a dough proofing system that allows the dough pieces to rest before they are molded and placed in pans for baking or further processing. Due to the difficulty in maintaining a constant weight of divided dough portions at high production rates, a need remains for a system to continuously monitor and control the weight of divided dough portions at high production rates without human intervention. Preferably, such a system would allow for optimal proofing time and minimize the variations in the weight of dough portions from a desired weight by automatically calculating and implementing precise adjustments to the controller of the dough feeding mechanism.

### SUMMARY OF THE INVENTION

The present invention satisfies these needs and provides an apparatus and method for continuously monitoring the weight of divided dough portions at high production speeds, and is capable of providing corrective signals proportional to the weight deviation of each dough portion or a predetermined number of portions in a sample group from the desired portion weight. The magnitude of the dividing mechanism feed rate control adjustment signal is also configurable for the specific application requirements.

One embodiment of the present invention comprises a production mechanism, a dough feed mechanism, a dividing mechanism, a weighing mechanism, a processor to calculate and transmit appropriate control signals to the dough feed mechanism, and a conveyor system configured to transport dough portions from the dividing mechanism to the proofer mechanism. The weighing mechanism can include a weigh bucket configured to receive dough portions from the proofer. The weigh bucket is mounted to a load cell.

The dividing mechanism or means for dividing can be configured to receive a continuous flow of semi-solid matter from the feed mechanism or means for feeding and to divide the semi-solid matter into portions sized in proportion to the operating rate of the feed mechanism or means for feeding.

The weigh bucket can be configured to release the dough portions from the weigh bucket when the proofer tray is underneath the weigh bucket, positioned to receive the contents of the weigh bucket. The proofer tray that receives the dough portions released from the weigh bucket can be the same proofer that delivered those dough portions to the weigh bucket, or a different proofer tray. Once the dough portions are returned to a proofer tray from the weigh bucket, they obtain further processing in the proofer. The embodiment can include a tipping mechanism wherein the tipping mechanism tips the proofer tray to allow the portion in the proofer tray to fall to the weigh bucket. The speed of the tip mechanism and weigh time is variable to accommodate the range of production speeds.

Another embodiment of the present invention comprises a means for feeding a semi-solid matter, a dividing means, a means for proofing, a means for weighing, and a processor in communication the matter feeding means and the weighing means. The means for weighing includes a load cell for producing indications representative of a weight of a portion of the semi-solid matter. The means for weighing can be configured to release the portion from the means for weighing when the means for proofing is underneath the means for weighing, positioned to receive the contents of the means for weighing. The means for proofing that receives the portions can be the same means for proofing that delivered the portions to the means for weighing, or a different means for proofing. Once the portions are returned to the means for proofing from the means for weighing, they obtain further processing in the means for proofing. The embodiment can include a tipping mechanism where in the tipping mechanism tips the means for proofing to allow the portion in the means for proofing to fall to the means for weighing. The speed of the tip mechanism and weigh time is variable to accommodate the range of production speeds.

Additional embodiments include methods of continuously dividing a mass of semisolid matter into a plurality of portions, each portion having a preselected target weight and methods of providing a dough proofing system. The method of providing can include providing a feed device or means for feeding, providing a dividing mechanism or means for dividing, providing a conveyor configured to receive and transport the portions from the dividing mechanism or means for dividing, providing a proofer or means for proofing, providing a load cell, providing a programmed processor in electrical communication with the feed device or means for feeding. The feed device or means for feeding can be motor-driven. The methods of continuously dividing a mass of semisolid matter into a plurality of portions, each portion having a preselected target weight can include feeding a mass of semi-solid matter to a dividing mechanism, or means for dividing, with a feed rate that is controlled by inputting an operating rate control signal; dividing the mass of semi-solid matter into portions; transporting the portions from the dividing mechanism, or means for dividing; receiving the portions from the conveyor on a proofer tray, or means for proofing, downstream from the conveyor configured to transport the portions from the conveyor to a weigh bucket, or means for weighing; measuring the weight of the empty weigh bucket, or means for weighing, and the weight of the portions inside the weigh bucket, or means for weighing; inputting the operating rate control signal; inputting an initial tare weight for the weigh bucket, or means for weighing.

The apparatus can remove a complete proofer tray of dough pieces from the proofer, weighing each dough piece individually at rest inside the individual weigh buckets or means for weighing. The user may select the percentage of the entire dough piece population for weight sampling. The weight sampling can be variable, for example, every fourth tray or 25 percent of the dough piece population. This weight sample information is calculated in comparison to the desired dough piece target weight. A corrective signal is sent to the portioning device to continuously produce constant weight portions of dough, and more particularly, to such apparatus and method whereby variations in the weight of each portion are minimized by automatically adjusting the rate at which the dough is fed to the dividing mechanism.

The weighing mechanism can consist of a tipping apparatus that causes the dough portions to fall from the moving proofer trays, or means for proofing, that carry the portions to the weigh bucket or means for weighing. After the proofer tray or means for proofing is tipped, the dough portions fall in to a weigh bucket or means for weighing. In some embodiments, the dough portions can fall into two or more weigh buckets or means for weighing. The weigh bucket or means for weighing can hold the dough portion until the same proofer tray or means for proofing arrives beneath it. In other embodiments, the weigh bucket or means for weighing can release the dough portion to a proofer tray or means for proofing other than the one that delivered the portion to the weigh bucket or means for weighing. The dough portions travel forward into the process stream without interruption before molding.

The method can include inputting an initial operating rate control signal or use the optimum saved control signal derived from prior production data of a given variety to the feed device or means for feeding and inputting an initial tare weight for each weigh bucket or means for weighing. The initial tare weight can be an allowable maximum tare weight. The method can include dividing portions of semi-solid matter from the mass using the dividing mechanism or means for dividing, obtaining a group of a predetermined number of successive weight indications from the load cell, and calculating the average weight indication of the group. The method can include determining whether all of the weight indications in the group fall within a predetermined standard deviation of the average weight indication of the group, and if so, calculating the difference between the average weight and the sum of the target weight and the tare weight of the weigh bucket or means for weighing.

If the difference between the average weight and the sum of the target weight and the tare weight of the weigh bucket or means for weighing is greater than a predetermined tare set point, the method can include adjusting the control signal according to the difference between the average weight and the sum of the target weight and the tare weight. In other embodiments, if the difference is greater than the predetermined tare set point, the method can involve including the average weight indication in an array of a predetermined number of weight samples, and calculating the average of the weight samples in the array, and adjusting the control signal according to the difference between the average sample weight and the sum of the target weight and the tare weight. If the difference is less than the predetermined tare set point, the method can include using the average weight as the tare weight for subsequent weight indications.

In one embodiment, the weight sampling is every fourth tray, with 100 dough piece portions providing 25 weight samples per minute. This weight sample information is calculated in comparison to the desired dough piece target weight. A corrective signal is sent to the portioning device to continuously produce constant weight portions of dough, and more particularly, to such apparatus and method whereby variations in the weight of each portion are minimized by automatically adjusting the rate at which the dough is fed to the dividing mechanism or means for dividing. Adjustments to the portion size can thus be made by varying the control input to the servo controlled dough metering device.

As the dough portion falls from the proofer tray or means for proofing it directs the portion into a weigh bucket or other means for weighing. The weigh bucket or other means for weighing is supported by a load cell which provides an indication of the displacement of a resilient counterforce due to the weight of the portion. Various types of counterforces, such as springs or elastomeric materials, can be used in the load cell. The displacement of the counterforce can be measured most readily by devices which exhibit varying electrical properties under physical deformation or displacement, such as strain gages, transducers or forced motor. The analog electrical indications generated by the load cell can be converted by an analog to digital converter (′A/D″) to a digital signal compatible for input to the weight signal processor. The load cell used with the weigh bucket or means for weighing may utilize a load cell body or counter force that is submerged in an engineered high density fluid to provide impact cushioning and limit the post impact oscillation (“ringing”) of the counter force due to the impact of the dough portion on the weigh bucket or means for weighing.

The weight signal processor converts the electrical indications generated by the load cell at a sampling rate of up to 1,000 weight samples per second, and uses a computer algorithm to place these sample weight indications in to an array of selectable size for statistical analysis.

The array size is selected to encompass weight indications taken during a timeframe that is less than the interval during which a single portion is at rest on the load cell at production rates, so that the weight indications can be statistically analyzed to determine an accurate portion weight. Also, because an accurate net portion weight is dependent upon subtraction of an accurate weight of the empty load cell (tare weight) from the total load cell reading, the array size is also preferably selected to encompass a series of weight indications taken during a timeframe that is also less than the interval between the time a portion is fully removed from the load cell and the time the next portion is first deposited in contact with the load cell, so that the weight indications of the empty load cell during production conditions can be statistically analyzed to determine an accurate tare weight.

Because production rates can be in the range of 180 portions per minute or more, the cycle time for loading and unloading a single portion is one third of a second. Accordingly, the array size for the fully loaded and unloaded time intervals within that cycle will be on the order of 0.1 seconds, or approximately 100 samples each. These intervals represent the time while the single dough portion is at rest on the load cell or alternatively when there is no dough portion on the load cell. The algorithm is thus devised to identify arrays of sequential sample indications which fall within a predetermined standard deviation of the average weight indication of the array. By rejecting arrays having erratic weight indications outside of the standard deviation, only the arrays which do not include weight indications taken while the dough portion is either being placed on the load cell or removed from the load cell will be used to determine the tare weight and the net portion weight and to control the portion size produced by the dividing mechanism or means for dividing. This algorithm eliminates data samples which do not provide valid indications of the load cell with the dough portion in place or alternatively the unloaded load cell

These samples enter and exit the array first-in, first-out (FIFO) order. The standard deviation of the data in the array is recalculated upon the entry of every new sample. When the standard deviation of the weight samples is within the predetermined level, indicating that the array represents data taken during the time that a single dough portion is at rest on the load cell or alternatively when there is no dough portion on the load cell, an averaged weight is calculated using the array data. If the calculated average weight indication is above the predetermined tare set point, it is determined to be near the prior calculated individual dough piece weight plus the prior calculated tare weight, and a new individual dough piece weight is calculated using the new average individual dough piece weight minus the current calculated tare weight. Alternatively, if the calculated average weight indication is below the predetermined tare set point, it is determined to be near the prior calculated tare weight, and the new calculated average weight indication is used as the new tare weight. When the standard deviation of the weight samples exceed the predetermined level, the weight data in the array includes readings taken when the weigh bucket or other means for weighing is either loading or unloading a dough piece and is not used. This process is repeated for successive array data to compile a sample group of dough portion weights which can be averaged and filtered and compared to the desired portion weight.

The weight signal processor compares the weight of each dough portion in each sample group to the desired dough portion weight and automatically calculates a signal which is sent to the controller of the dough pump or other feed mechanism or means for feeding supplying the dividing mechanism or means for dividing to increase or decrease the amount of dough passing through the dividing mechanism or means for dividing during each cut cycle, thereby providing continuous divided dough weight monitoring and control.

### BRIEF DESCRIPTION OF THE DRAWINGS

The invention will now be further described in conjunction with the drawings, in which:

FIG. 1 is a diagram illustrating the system and method of one embodiment of the present invention with a typical arrangement of dough processing equipment in a commercial bakery for buns, rolls, or muffins; and

FIG. 2 is a flow chart diagram illustrating the method of one embodiment of the present invention.

These drawings are provided for illustrative purposes only, and should not be used to unduly limit the scope of the Invention.

### DETAILED DESCRIPTION OF THE PREFERRED EMBODIMENT

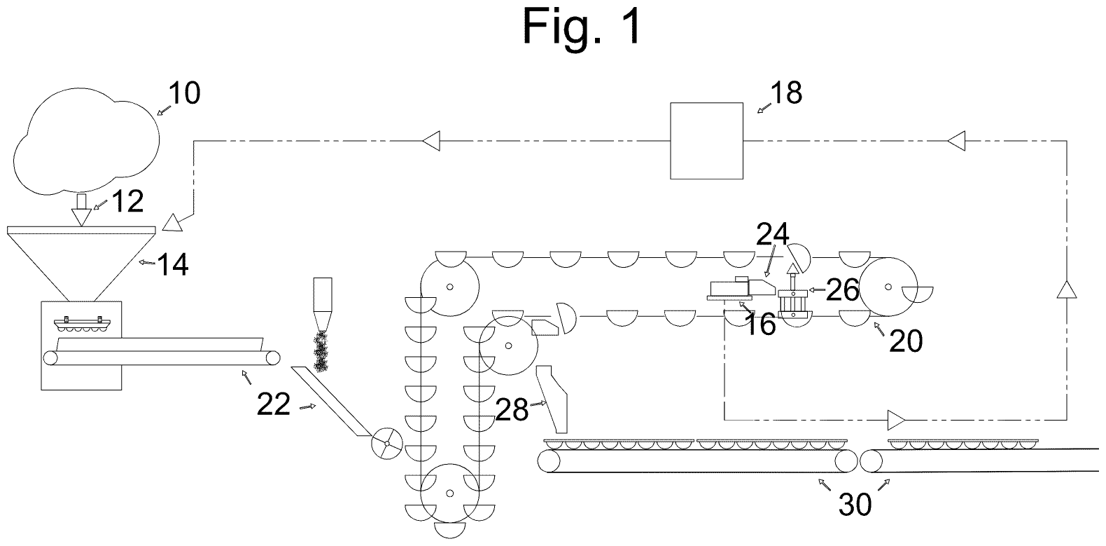

As shown in FIG. 1, one embodiment of the present invention comprises a dough production mechanism 10, a dough feed mechanism 12, a dividing mechanism 14, a weighing mechanism 16, a weight signal processor 18 to calculate and transmit appropriate control signals to the dough feed mechanism 12, proofer mechanism 20, a conveyor system 22 configured to transport dough portions from the dividing mechanism to the proofer mechanism 20, a weigh bucket 24, a tipping mechanism 26 to place dough portions on the weigh bucket 24, that reinsert the dough pieces in position for further processing. The weighing mechanism 16 can include a weigh cell or load cell. The speed of the weigh bucket release is variable to accommodate the range of production speeds. FIG. 1 illustrates a typical dividing mechanism 14 that is capable of cutting dough pieces at very high production rates. Once portioned, the dough pieces fall to a rounder conveyor 22 that shapes the dough pieces into spheres and delivers them to a flouring area, where the dough pieces are loaded in to the proofer trays on proofer 20. The dough pieces are allowed to rest as they are conveyed through the proofer 20. As illustrated in FIG. 1, a weigh bucket 24 is positioned under the proofer 20 supported by support structure. To take a weight sample, a pneumatic tray tipper 26 extends, causing the dough pieces to fall from the proofer tray in to the weigh bucket 24. As the dough pieces are weighed, the weighing mechanism 16 that the weigh bucket 24 is mounted to, provides very precise weight samples at up to 1,000 times per second. The weigh bucket 24 is at least partially supported by the weighing mechanism 16 when the weight measurement is taken. Weighing mechanism 16 delivers this information to a computer 18 for processing. As the dough pieces are discharged from the weigh bucket 24, they are conveyed to a molder 28 and fed into baking pans on a pan indexing conveyor 30.

The weight data is processed by an algorithm running on the computer 18. In the algorithm, the weights of samples are placed in to an array of selectable size. These sample weights enter and exit the array first-in first-out order. The standard deviation of the data in the array is recalculated when each new sample weight is processed.

In another embodiment, the apparatus for producing a plurality of portions of semi-solid matter, each portion having a substantially uniform preselected target weight comprises a means for feeding a semi-solid matter to a dividing means at a rate which varies in response to a control signal. The matter feeding means can be a vertical, incline, horizontal, or rotary conveyor, pump, or trough that releases the dough into the means for dividing. In the embodiment shown in FIG. 1, the matter feeding means is dough feed mechanism 12. The embodiment can include a means for proofing the matter downstream from the dividing means wherein the matter is stored for processing. The means for proofing can be a tray, square, round, circular, or container of other geometric shape partially exposed to the environment. The means for proofing can include one or more proofing containers. In the embodiment shown in FIG. 1, the means for proofing includes a plurality of proofing trays that are semi-circular in shape. The embodiment can include a means for weighing configured to release the portion from the means for weighing when a means for weighing is positioned underneath the means for weighing. In some embodiments, the means for proofing is the same means for proofing that delivered the portion to the means for weighing. In other embodiments, the means for proofing is not the same means for proofing that delivered the portion to the means for weighing. The weighing means can be a partially or fully enclosed bucket, conveyor, platform, scale, or balance. In the embodiment shown in FIG. 1, the weighing means consists of weighing mechanism 16 and weigh bucket 24. The dividing means can be an industrial cutter, knife, saw, chopper, or blade. In the embodiment shown in FIG. 1, the dividing means is dividing mechanism 14.

In some embodiments, the processor is programmed to receive a group of a predetermined number of successive weight indications from the load cell, calculate the average weight indication of the group, determine whether all of the weight indications in the group fall within a predetermined standard deviation of the average weight indication of the group, and if so, calculate the difference between the average weight and the sum of the target weight and the tare of the empty means for weighing; and if the difference is less than a predetermined tare set point, to use the average weight as the tare weight for subsequent weight indications; and if the difference is greater than the predetermined tare set point, to include the average weight indication of the group in an array of a predetermined number of weight samples, calculate the average of the weight samples in the array, and adjust the control signal according to the difference between the average sample weight and the sum of the target weight and the tare weight.

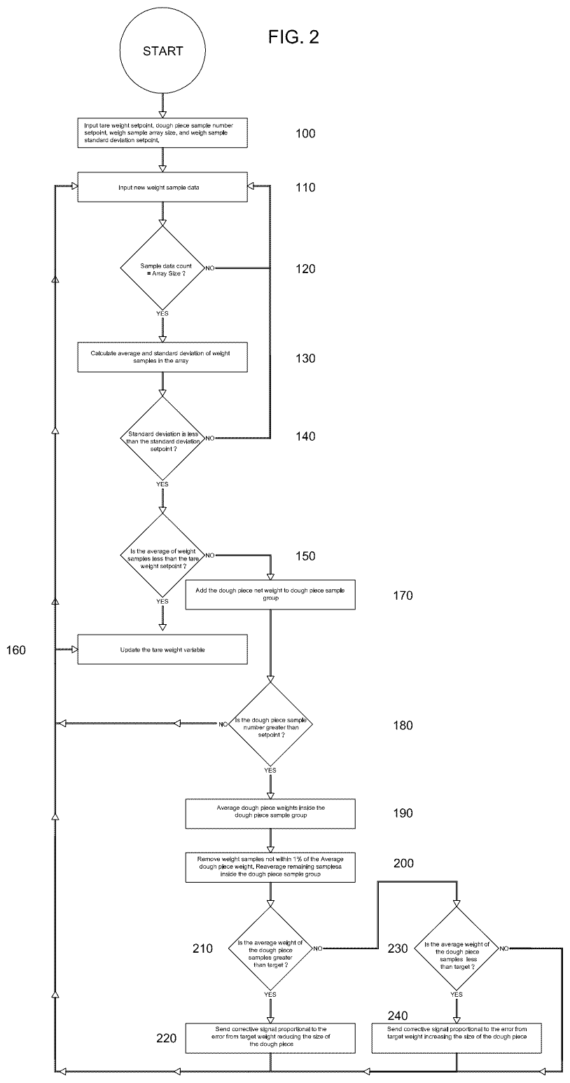

FIG. 2 is a flow chart diagram illustrating the method of one embodiment of the present invention. As shown in FIG. 2, at step 100, the tare set point, desired array size, and the predetermined standard deviation are input.

At step 120, if the new weight sample along with the prior weight samples input are sufficient in number to complete the array, the process proceeds to step 130. If the sample count data points in the array is not sufficient to complete the array, the process reverts to step 110 for input of additional weight sample data.

If the array was previously full, as each new weight sample data is added, the oldest prior weight sample data entry is deleted from the array.

At step 130, the average and standard deviation of the data in the array are calculated. At step 140, if the standard deviation is less than the predetermined standard deviation limit, the process continues to step 150. If the standard deviation exceeds the predetermined limit, the process reverts to step 110 for the input of additional weight sample data until the data in the array is sufficiently consistent to meet the standard deviation limitation.

At step 150, the average of the array weight samples is compared to the predetermined tare set point. If the average weight is less than the tare set point, the array comprises weight sample data from the unloaded load cell, and is used to update the tare weight variable at step 160. This updated tare weight variable is subsequently used to calculate the net weight of the dough portions. Upon completion of this updating of the tare weight variable, the process reverts to step 110 for the input of additional weight sample data.

Alternatively, if the average weight of the array data is greater than the tare set point, the data represents load cell indications taken while a dough portion is at rest on the load cell, and the tare weight variable is subtracted from this average load cell reading to calculate the dough piece net weight at step 170. This dough piece net weight data is also included in the dough piece sample set at step 170.

The dough piece sample group is of a user selected size, normally comprising a group of 8 to 12 dough piece weights. This group of weights is averaged and compared to the desired dough piece weight to determine if a corrective signal is required.

As shown in step 180, if the number of dough piece sample data points is less than the predetermined number of dough piece samples in the group, the process reverts back to step 110 for the input of further data. Alternatively, if the dough piece sample group size is sufficient, at step 190 the average of the dough piece weight data in the dough sample group is calculated.

Various methods of filtering the data in the dough sample group may be used. For example, as illustrated in step 200, any weight sample data varying more than 1% from the average dough piece weight can be eliminated from the dough sample group, and then the average dough piece weight to is recalculated using the more restrictive sample group data, to provide an average which is unaffected by erratic sample weight data. Other methods to filter data include eliminating the two data points in each sample group having the greatest deviation from the average dough piece weight data and to then recalculate the average dough piece weight using the more restrictive sample group data.

As shown in step 210, if the average weight of the dough pieces in the filtered sample group is greater than the target weight, at step 220, a corrective signal proportional to the deviation from the target weight is sent to the dividing mechanism to reduce the size of the dough piece. After the corrective signal is sent to the dividing mechanism, the process reverts back to step 110.

Conversely if the average weight of the dough pieces is not greater than the target portion weight, at step 230 if the average of the sample group is less than the desired portion weight, at step 240, a corrective signal proportional to the deviation from the target weight is sent to the dividing mechanism to increase the size of the dough piece. After the corrective signal is sent to the dividing mechanism, the process reverts back to step 110.

If the sample group average weight is equal to the target weight, no corrective signal is sent to the dividing mechanism, and the process reverts to step 110.

The weight signal processor 18 compares the weight of each dough portion in each sample group to the desired dough portion weight and automatically calculates a signal which is sent to the controller of the dividing mechanism 14 to increase or decrease the amount of dough passing through the cutting mechanism during each cut cycle, thereby providing continuous divided dough weight monitoring and control.

In one embodiment, the present invention comprises a mechanism that produces semi-solid dough, a dividing mechanism that divides the semi-solid matter into portions and a device that feeds the semi-solid matter to the dividing mechanism and has an operating rate that is controlled by inputting a control signal. The control signal corresponds to a numerical value, and the feed device has an upper operating rate corresponding to an upper operating rate control signal, at which rate portions having maximum weight are divided, and a lower operating rate corresponding to a lower operating rate control signal, at which rate minimum weight portions are divided. The step of adjusting the control signal according to the difference between the average weight and the sum of the target weight and the tare weight comprises adjusting the numerical value of the operating rate control signal by an amount equal to the difference between the numerical value of the upper operating rate control signal and the numerical value of the lower operating rate control signal, multiplied by the (sum of the target weight and the tare weight less the average weight), multiplied by a predetermined moderating factor. The predetermined moderating factor is preferably the reciprocal of the target weight, or some fractional part of the reciprocal of the target weight.

Thus, in one embodiment, the present invention comprises a method of providing a dough proofing system for continuously dividing a mass of semisolid matter into a plurality of portions, each portion having a preselected target weight, including the steps of: providing a device that feeds a mass of semi-solid matter to a dividing mechanism and has an operating rate that is controlled by inputting an operating rate control signal; providing the dividing mechanism that divides the matter into portions; providing a conveyor configured to receive and transport the portions from the dividing mechanism; providing a proofer downstream from the conveyor configured to receive and transport the portions of semi-solid matter from the conveyor to a weigh bucket; providing a load cell to support the weigh bucket that provides an indication of the weight of the empty weigh bucket and the weight of the dough portions inside the weigh bucket; providing a processor in electrical communication with the device that feeds the semi-solid matter to the dividing mechanism and the load cell. In some embodiments, the method can include providing a tipper for tipping the proofer to deliver the matter in the proofer to the weigh bucket, or mechanism for weighing.

In another embodiment, the present invention includes a method of continuously dividing a mass of semisolid matter into a plurality of portions, each portion having a preselected target weight, comprising the steps of: feeding a mass of semi-solid matter to a dividing mechanism, or means for dividing, with a feed rate that is controlled by inputting an operating rate control signal; dividing the mass of semi-solid matter into portions using the dividing mechanism, or means for dividing; transporting the portions from the dividing mechanism, or means for dividing, on a conveyor; receiving the portions from the conveyor on a proofer, or means for proofing, downstream from the conveyor configured to transport the portions from the conveyor to a weigh bucket, or means for weighing; measuring the weight of the empty weigh bucket, or means for weighing, and the weight of the portions inside the weigh bucket, or means for weighing, using a load cell that supports the weigh bucket, or means for weighing; inputting the operating rate control signal to the device that feeds the semi-solid matter to the dividing mechanism, or mans for feeding; inputting an initial tare weight for the weigh bucket, or means for weighing; obtaining a group of a predetermined number of successive weight indications from the load cell; calculating the average weight indication of the group; determining whether all of the weight indications in the group fall within a predetermined standard deviation of the average weight indication of the group, and if so, calculating the difference between the average weight and the sum of the target weight and the tare weight of the empty weigh bucket, or means for weighing; and if the difference is less than a predetermined tare set point, using the average weight as the tare weight for subsequent weight indications; and if the difference is greater than the predetermined tare set point, including the average weight indication of the group in an array of a predetermined number of weight samples, calculating the average of the weight samples in the array, and adjusting the operating rate control signal according to the difference between the average sample weight and the sum of the target weight and the tare weight.

In another embodiment, the present invention comprises a method of providing a dough proofing system continuously dividing a mass of semisolid matter into a plurality of portions, each portion having a preselected target weigh, including the steps of: providing a means for feeding a semi-solid matter to a means for dividing at a rate which varies in response to an operating rate control signal; providing a means for dividing that divides the matter into portions; providing a conveyor configured to receive and transport the portions from the means for dividing; providing a means for proofing downstream from the conveyor configured to receive and transport the portions of semi-solid matter from the conveyor to a means for weighing; providing a load cell to support the means for weighing that provides an indication of the weight of the empty means for weighing and the weight of the portions in the means for weighing; providing a processor in electrical communication with the means for feeding and the load cell.

The method of one embodiment of the present invention can be utilized with multiple weigh buckets or means for weighing to accommodate a proofer designed for multiple lanes of dough piece processing. The support structure can be made wide enough for multiple weigh buckets in one or more lanes of dough piece processing.

Although the subject invention has been described in use primarily with respect to dough, the invention is applicable to many other production processes involving controlled weight portions of semi-solid matter, including but not limited to agricultural and food products, polymers, plastics, resins, cellulose, gelatins, refractory products, ceramics and the like. Many changes, modifications, variations, combinations, sub combinations and other uses and applications of the subject invention will be and become apparent to those skilled in the art after considering this specification and the accompanying drawings, which disclose a preferred embodiment thereof. All such changes, modifications, variations, and other uses and applications that do not depart from the spirit and scope of the invention are deemed to be covered by the invention, which is to be limited only by the claims which follow.

What is claimed is:

1. An apparatus for producing a plurality of portions of semi-solid matter, each portion having a substantially uniform preselected target weight, comprising:
a feed mechanism that has an operating rate that is controlled by inputting a control signal;
a dividing mechanism configured to receive a continuous flow of the semi-solid matter from the feed mechanism and to divide the semi-solid matter into portions sized in proportion to the operating rate of the feed mechanism;
a proofer downstream from said dividing mechanism configured to receive and transport the portions as the portions are released from the dividing mechanism;
a weigh bucket having a tare weight downstream from said proofer configured to receive the portions from the proofer, the weigh bucket having a load cell configured for producing indications representative of the weight of a portion resting in the weigh bucket, wherein the portion resting in the weigh bucket is released when the proofer is positioned underneath the weigh bucket;
a processor in electrical communication with the feed mechanism and the load cell, the processor programmed to:
send the operating rate control signal to the feed mechanism,
receive a group of a predetermined number of successive weight indications from the load cell,
calculate the average weight indication of the group,
determine whether all of the weight indications in the group fall within a predetermined standard deviation of the average weight indication of the group, and if so,
calculate the difference between the average weight and the sum of the target weight and the tare weight of the weigh bucket;
and if the difference is less than a predetermined tare set point, to use the average weight as the tare weight for subsequent weight indications;
and if the difference is greater than the predetermined tare set point, to include the average weight indication of the group in an array of a predetermined number of weight samples,
calculate the average of the weight samples in the array, and
adjust the operating rate control signal according to the difference between the average sample weight and the sum of the target weight and the tare weight of the weigh bucket.

2. The apparatus of claim 1 wherein the weigh bucket is configured to accommodate a single portion, and the predetermined number of successive weight indications received from the load cell is selected to encompass a time period less than the interval between loadings of successive portions in to the weigh bucket.

3. The apparatus of claim 2 wherein the predetermined number of successive weight indications received from the load cell is selected to encompass a time period less than the interval between the loading and unloading of a single portion.

4. The apparatus of claim 2 wherein the predetermined number of successive weight indications received from the load cell is selected to encompass a time period less than the interval between the unloading of a single portion and the loading of the next successive portion.

5. The apparatus of claim 1 wherein the load cell comprises a strain gauge load cell.

6. The apparatus of claim 1 further comprising a tipping mechanism wherein the tipping mechanism tips the proofer to allow the portion in the proofer to fall to the weigh bucket.

7. The apparatus of claim 1 wherein the portion is released from the weigh bucket when the proofer that delivered the portion to the weigh bucket is positioned underneath the weigh bucket.

8. An apparatus for producing a plurality of portions of semi-solid matter, each portion having a substantially uniform preselected target weight, comprising:
a means for feeding a semi-solid matter to a dividing means at a rate which varies in response to an operating rate control signal;
a means for proofing the matter downstream from the dividing means wherein the matter is stored for processing;
a means for weighing that receives the matter from the means for proofing, having a load cell for producing indications representative of a weight of a portion of the semi-solid matter, the means for weighing configured to release the portion from the means for weighing when the means for proofing is positioned underneath the means for weighing;
a processor in communication with the means for feeding and means for weighing for providing the operating rate control signal to the means for feeding,
wherein the process is programmed to
receive a group of a predetermined number of successive weight indications from the load cell,
calculate the average weight indication of the group,
determine whether all of the weight indications in the group fall within a predetermined standard deviation of the average weight indication of the group, and if so, calculate the difference between the average weight and the sum of the target weight and the tare weight of the empty means for weighing;
and if the difference is less than a predetermined tare set point, to use the average weight as the tare weight for subsequent weight indications;
and if the difference is greater than the predetermined tare set point, to include the average weight indication of the group in an array of a predetermined number of weight samples, calculate the average of the weight samples in the array, and adjust the operating rate control signal according to the difference between the average sample weight and the sum of the target weight and the tare weight.

9. The apparatus of claim 8 wherein the means for weighing is configured to accommodate a single portion, and the predetermined number of successive weight indications received from the load cell is selected to encompass a time period less than the interval between loadings of successive portions in to the means for weighing.

10. The apparatus of claim 9 wherein the predetermined number of successive weight indications received from the load cell is selected to encompass a time period less than the interval between the loading and unloading of a single portion.

11. The apparatus of claim 9 wherein the predetermined number of successive weight indications received from the load cell is selected to encompass a time period less than the interval between the unloading of a single portion and the loading of the next successive portion.

12. The apparatus of claim 8 wherein the load cell comprises a strain gauge load cell.

13. The apparatus of claim 8 further comprising a tipping mechanism wherein the tipping mechanism tips the means for proofing to allow the portion in the means for proofing to fall to the means for weighing.

14. The apparatus of claim 8 where in the portion is released from the means for weighing when the means for proofing that delivered the portion to the means for weighing is positioned underneath the means for weighing.

15. A method of providing a dough proofing system for continuously dividing a mass of semisolid matter into a plurality of portions, each portion having a preselected target weight, comprising the steps of:
providing a device that feeds a mass of semi-solid matter to a dividing mechanism and has an operating rate that is controlled by inputting an operating rate control signal;
providing the dividing mechanism that divides the matter into portions;
providing a conveyor configured to receive and transport the portions from the dividing mechanism;
providing a proofer downstream from the conveyor configured to receive and transport the portions of semi-solid matter from the conveyor to a weigh bucket;
providing a load cell to support the weigh bucket that provides an indication of the weight of the empty weigh bucket and the weight of the portions inside the weigh bucket;
providing a processor in electrical communication with the device that feeds the semi-solid matter to the dividing mechanism and the load cell, the processor programmed to:
obtain a group of a predetermined number of successive weight indications from the load cell;
calculate the average weight indication of the group;
determine whether all of the weight indications in the group fall within a predetermined standard deviation of the average weight indication of the group, and if so, calculating the difference between the average weight and the sum of the target weight and the tare weight of the empty weigh bucket;
and if the difference is less than a predetermined tare set point, use the average weight as the tare weight for subsequent weight indications;
and if the difference is greater than the predetermined tare set point, including the average weight indication of the group in an array of a predetermined number of weight samples, calculate the average of the weight samples in the array, and adjust the operating rate control signal according to the difference between the average sample weight and the sum of the target weight and the tare weight.

16. The method of claim 15 wherein the operating rate control signal corresponds to a numerical value, and the device that feeds the mass of semi-solid matter to the dividing mechanism has an upper operating rate corresponding to an upper operating rate control signal, at which rate portions having maximum weight are divided, and a lower operating rate corresponding to a lower operating rate control signal, at which rate minimum weight portions are divided; and the step of adjusting the operating rate control signal according to the difference between the average weight and the sum of the target weight and the tare weight comprises adjusting the numerical value of the operating rate control signal by an amount equal to the difference between the numerical value of the upper operating rate control signal and the numerical value of the lower operating rate control signal, multiplied by the (sum of the target weight and the tare weight less the average weight), multiplied by a predetermined moderating factor.

17. The method of claim 16 wherein the predetermined moderating factor is the reciprocal of the target weight.

18. The method of claim 15 wherein the weigh bucket is configured to accommodate a single portion and the predetermined number of successive weight indications received from the load cell is selected to encompass a time period less than the interval between loadings of successive portions in to the weigh bucket.

19. The method of claim 18 wherein the predetermined number of successive weight indications received from the load cell is selected to encompass a time period less than the interval between the loading and unloading of a single portion in the weigh bucket.

20. The method of claim 18 wherein the predetermined number of successive weight indications received from the load cell is selected to encompass a time period less than the interval between the unloading of a single portion and the loading of the next successive portion in to the weigh bucket.

21. The method of claim 15 further comprising:
providing a tipper for tipping the proofer to deliver the matter in the proofer to the weigh bucket.

22. A method of continuously dividing a mass of semisolid matter into a plurality of portions, each portion having a preselected target weight, comprising the steps of:
feeding a mass of semi-solid matter to a dividing mechanism with a feed rate that is controlled by inputting an operating rate control signal;
dividing the mass of semi-solid matter into portions using the dividing mechanism;
transporting the portions from the dividing mechanism on a conveyor;
receiving the portions from the conveyor on a proofer tray downstream from the conveyor configured to transport the portions from the conveyor to a weigh bucket;
measuring the weight of the empty weigh bucket and the weight of the portions inside the weigh bucket using a load cell that supports the weigh bucket;
inputting the operating rate control signal to the device that feeds the semi-solid matter to the dividing mechanism;
inputting an initial tare weight for the weigh bucket;
obtaining a group of a predetermined number of successive weight indications from the load cell;
calculating the average weight indication of the group;
determining whether all of the weight indications in the group fall within a predetermined standard deviation of the average weight indication of the group, and if so, calculating the difference between the average weight and the sum of the target weight and the tare weight of the empty weigh bucket;
and if the difference is less than a predetermined tare set point, using the average weight as the tare weight for subsequent weight indications;
and if the difference is greater than the predetermined tare set point, including the average weight indication of the group in an array of a predetermined number of weight samples, calculating the average of the weight samples in the array, and adjusting the operating rate control signal according to the difference between the average sample weight and the sum of the target weight and the tare weight.

23. A method of providing a dough proofing system for continuously dividing a mass of semisolid matter into a plurality of portions, each portion having a preselected target weight, comprising the steps of:
providing a means for feeding a semi-solid matter to a means for dividing at a rate which varies in response to an operating rate control signal;
providing a means for dividing that divides the matter into portions;
providing a conveyor configured to receive and transport the portions from the means for dividing;
providing a means for proofing downstream from the conveyor configured to receive and transport the portions of semi-solid matter from the conveyor to a means for weighing;
providing a load cell to support the means for weighing that provides an indication of the weight of the empty means for weighing and the weight of the portions in the means for weighing;
providing a processor in electrical communication with the means for feeding and the load cell, the processor programmed to:
obtain a group of a predetermined number of successive weight indications from the load cell;
calculate the average weight indication of the group;
determine whether all of the weight indications in the group fall within a predetermined standard deviation of the average weight indication of the group, and if so, calculating the difference between the average weight and the sum of the target weight and the tare weight of the empty weigh bucket;
and if the difference is less than a predetermined tare set point, use the average weight as the tare weight for subsequent weight indications;
and if the difference is greater than the predetermined tare set point, including the average weight indication of the group in an array of a predetermined number of weight samples, calculate the average of the weight samples in the array, and adjust the operating rate control signal according to the difference between the average sample weight and the sum of the target weight and the tare weight.

24. The method of claim 23 wherein the operating rate control signal corresponds to a numerical value, and the means for feeding has an upper operating rate corresponding to an upper operating rate control signal, at which rate portions having maximum weight are divided, and a lower operating rate corresponding to a lower operating rate control signal, at which rate minimum weight portions are divided; and
the step of adjusting the control signal according to the difference between the average weight and the sum of the target weight and the tare weight comprises adjusting the numerical value of the operating rate control signal by an amount equal to the difference between the numerical value of the upper operating rate control signal and the numerical value of the lower operating rate control signal, multiplied by the sum of the target weight and the tare weight less the average weight, multiplied by a predetermined moderating factor.

25. The method of claim 24 wherein the predetermined moderating factor is the reciprocal of the target weight.

26. The method of claim 23 wherein each means for weighing is configured to accommodate a single portion and the predetermined number of successive weight indications received from the load cell is selected to encompass a time period less than the interval between loadings of successive portions in to the means for weighing.

27. The method of claim 26 wherein the predetermined number of successive weight indications received from the load cell is selected to encompass a time period less than the interval between the loading and unloading of a single portion in to the means for weighing.

28. The method of claim 26 wherein the predetermined number of successive weight indications received from the load cell is selected to encompass a time period less than the interval between the unloading of a single portion and the loading of the next successive portion in to the means for weighing.

29. The method of claim 23 wherein the step of obtaining a group of a predetermined number of successive weight indications is performed by an apparatus comprised of the means for weighing and a strain gauge load cell.

30. A method of continuously dividing a mass of semisolid matter into a plurality of portions, each portion having a preselected target weight, comprising the steps of:
feeding a mass of semi-solid matter to a means for dividing at a rate which varies in response to an operating rate control signal;
dividing the mass of semi-solid matter into portions using the means for dividing;
transporting the portions from the means for dividing on a conveyor;
receiving the portions from the conveyor on a means for proofing downstream from the conveyor configured to transport the portions from the conveyor to a means for weighing;
measuring the weight of the empty means for weighing and the weight of the portions inside the means for weighing using a load cell that supports the means for weighing;
inputting the operating rate control signal to a means for feeding the mass of semi-solid matter to the means for dividing;
inputting an allowable maximum tare weight for the means for weighing;
obtaining a group of a predetermined number of successive weight indications from the load cell;
calculating the average weight indication of the group;
determining whether all of the weight indications in the group fall within a predetermined standard deviation of the average weight indication of the group, and if so, calculating the difference between the average weight and the sum of the target weight and the tare weight of the empty weigh buckets;
if the difference is greater than the predetermined tare set point, adjusting the control signal according to the difference between the average sample weight and the sum of the target weight and the tare weight;
and if the difference is less than a predetermined tare set point, using the average weight as the tare weight for subsequent weight indications.
